(19) United States
(12) Patent Application Publication
(10) Pub. No.: US 2003/0066729 A1
(43) Pub. Date: Apr. 10, 2003

(54) Multi-clutch arrangement

(75) Inventors: Reinhard Feldhaus, Niederwerrn (DE); Markus Heiartz, Wurzburg (DE); Andreas Orlamunder, Schweinfurt (DE); Jochen Kuhstrebe, Biebelried/Westheim (DE); Wolfgand Reisser, Sennfeld (DE); Thomas Wirth, Schwanfeld (DE); Michael Peterseim, Oberdorla (DE); Jurgen Dudenhoffer, Herbstadt (DE); Manfred Zimmer, Zeil (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/266,115

(22) Filed: Oct. 7, 2002

(30) Foreign Application Priority Data
Oct. 9, 2001 (DE) 101 49 702.4

(51) Int. Cl. F16D 21/06

(52) U.S. Cl. 192/48.8; 192/70.18

(57) ABSTRACT

A multi-clutch arrangement, especially a dual clutch arrangement, having at least two clutch areas, each with a pressure plate arrangement which is connected to a housing arrangement for rotation in common around an axis of rotation (A) and which can be shifted in the axial direction relative to the housing arrangement; with an opposing support arrangement; and with a clutch disk arrangement, the friction surface arrangement of which can be clamped between the pressure plate arrangement and the opposing support arrangement. Each of the clutch disk arrangements is designed to connected nonrotatably to a different power takeoff element. In the case of at least one of the clutch areas, preferably in all of the clutch areas, the pressure plate arrangement and the housing arrangement are connected to each other for rotation in common by a connecting element arrangement. When the clutch area is in the torque-transmitting state, it urges the pressure plate arrangement toward the opposing support arrangement.

### BACKGROUND OF THE INVENTION

1. Field of the Invention

The present invention pertains to a multi-clutch arrangement, especially to a dual clutch arrangement, comprising at least two clutch areas, each with a pressure plate arrangement, which is connected to a housing arrangement for rotation in common around an axis of rotation and which can be shifted in the axial direction with respect to the housing arrangement; with an opposing support arrangement; and with a clutch disk arrangement, the friction surface arrangement of which can be clamped between the pressure plate arrangement and the opposing support arrangement, where each of the clutch disk arrangements is designed to be a connected nonrotatably to a different power takeoff element.

2. Description of the Related Art

These types of multi-clutch arrangements, which are usually designed as dual clutch arrangements for the selectable activation of two different transmission input shafts, are often used in conjunction with so-called load-switching transmissions in trucks, in which very high torques must be transmitted. Clutch arrangements of this type are also being used increasingly in passenger vehicles because of the possibility of changing gears essentially without any interruption in the drive power. An essential criterion of these types of multi-clutch arrangements, in which one of the clutch areas is to be brought into the engaged state and another clutch area into the released state in alternation upon execution of the gear-shifting operation, is that the clutch-engaging and clutch-releasing operations must be carried out very quickly to prevent any interruption in the tractive force when shifts are made from one gear to another. Because comparatively large masses must be moved or comparatively large stored-energy devices must be actuated, especially in the case of the multi-clutch arrangements used in trucks, correspondingly strong and/or large actuating mechanisms are required to execute the clutch-engaging and clutch-releasing operations. These suffer from the disadvantage of comparatively long reaction times and/or comparatively large inert masses.

### SUMMARY OF THE INVENTION

The task of the present invention is to design a multi-clutch arrangement in such a way that it can be activated with comparatively small actuating forces without sacrificing its high torque-transmitting capacity.

According to a first aspect of the present invention, in the case of at least one of the clutch areas, preferably in all of the clutch areas, the pressure plate arrangement and the housing arrangement are connected to each other for rotation in common by a connecting element arrangement, which, when the clutch is in the torque-transmitting state, produces a force which tries to move the pressure plate arrangement toward the opposing support arrangement.

Because, according to the invention, a connecting element arrangement is provided which is designed to supply an additional force on the pressure plate arrangement, the actuating mechanism used to actuate the clutch arrangement, i.e., to actuate the clutch area in question, can be made smaller; that is, the actuating force which the actuating mechanism is designed to produce does not have to be as strong as it would have to be otherwise. As a result, the actuating mechanism can react more quickly to actuation commands, and thus the clutch operations to be executed can be accomplished very quickly.

In the case of the multi-clutch arrangement according to the invention, it is possible for the connecting element arrangement to comprise, for example, at least one leaf spring element, one circumferential end of which is connected to the pressure plate arrangement, whereas the other circumferential end is connected to the housing arrangement, this second circumferential end being offset with respect to the first circumferential end in the direction toward the opposing support arrangement.

As a result of the offset positioning and the resulting curvature along the length of each of the leaf spring elements, it is ensured that, while torque is being transmitted and thus while the pressure plate arrangement is being subjected to rotational force with respect to the housing arrangement, the one or more leaf spring elements produce the additional force desired as they attempt to stretch out in the circumferential direction.

It is preferable for the connecting element arrangement to comprise a plurality of leaf spring elements distributed around the circumference. It can be advantageous, especially for transmitting high torques and thus for obtaining the correspondingly stronger rotational connection between the housing arrangement and the pressure plate arrangement required for the transmission of such high torques, for each leaf spring element to comprise at least one leaf spring, preferably several leaf springs.

According to another aspect of the present invention, in the case of at least one of the clutch areas, the friction surface arrangement of the clutch disk arrangement has at least two friction areas, following each other in the direction of the axis of rotation and connected to each other for rotation in common; and where, between the minimum of two friction areas, an intermediate plate arrangement is provided, which is connected to the housing arrangement for rotation in common and which can be shifted in the axial direction relative to the housing arrangement.

Because, in the case of at least one clutch area, a so-called “multi-disk” arrangement is provided, it can be achieved that, as a result of the significant increase in the size of the friction surface made available, the clutch-engaging forces required to obtain a desired clutch torque can be reduced to an extent corresponding to the increase in the surface area. This also has the result that lighter-weight actuating mechanisms can be used, which then have correspondingly shorter reaction times.

To ensure that these types of multi-disk clutch areas can arrive in a released or engaged state in a defined manner, it is proposed that the friction areas be connected for rotation in common by toothed elements, which engage circumferentially with each other and which can be shifted in the axial direction relative to each other.

It is also possible in a multi-clutch arrangement of this type for the pressure plate arrangement and the housing arrangement in at least one of the clutch areas, but preferably in all of the clutch areas, to be connected for rotation in common by a connecting element arrangement, which, when the clutch area is in the torque-transmitting state, produces a force which tries to move the pressure plate arrangement toward the opposing support arrangement.

The measures according to the invention, which make it possible to decrease the required actuating forces, can, for example, be used when at least one of the clutch areas is pretensioned by a stored-energy device which has the effect of pushing the pressure plate arrangement toward the engaged position, whereas the job of moving the pressure plate arrangement into the released position is accomplished by the activation of an actuating mechanism. This means ultimately that at least one of the clutch areas works according to the normally-closed design principle and is thus brought into the released state by the actuating force produced by the actuating mechanism.

As an alternative, it is also obvious that at least one of the clutch areas can be moved into the engaged position by the activation of an actuating mechanism. The essential advantage of this type of clutch area, i.e., of an area working according to the normally-open design principle, is that, when there is a defect in the area of, for example, the actuating mechanism, the clutch area will move automatically into its open, that is, disengaged, state. The danger that several clutch areas could be engaged simultaneously and that several different paths of torque transmission with different reduction ratios could be acting in the same transmission at the same time can thus be excluded in practice.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal cross section through a first embodiment of a dual clutch arrangement according to the invention;

FIG. 2 shows a detailed view of the connection of a pressure plate of one of the clutch areas of the dual clutch arrangement shown in FIG. 1 to an actuating element;

FIG. 3 shows a partial radial view of the dual clutch arrangement shown in FIG. 1, illustrating a connecting element designed to reinforce the pressing force;

FIG. 4 show a corresponding view of an alternative embodiment of a dual clutch arrangement according to the invention;

FIG. 5 shows another view corresponding to FIG. 1 of an alternative embodiment of a dual clutch arrangement according to the invention, which has clutch areas built according to the principle of a multi-disk clutch;

FIG. 6 shows a detailed view of the dual clutch arrangement shown in FIG. 5, illustrating how the axial movement of an intermediate plate is controlled; and

FIG. 7 shows a view corresponding to FIG. 5 of another alternative embodiment of a dual clutch arrangement according to the invention.

### DETAILED DESCRIPTION OF THE PRESENTLY PREFERRED EMBODIMENTS

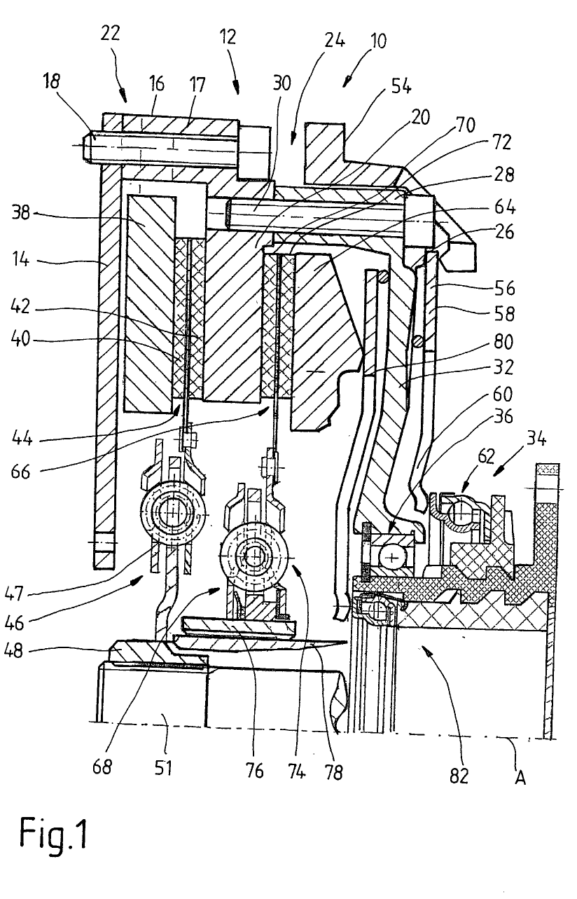

FIGS. 1-3 show a first embodiment of a dual clutch 10 having a housing arrangement 12 consisting of several parts. A disk-like part 14, which can be designed as a flywheel, as a secondary mass of a dual-mass flywheel, or as a driver plate, etc., has the job of connecting the dual clutch 10 to a drive shaft, such as a crankshaft of an internal combustion engine, for rotation in common. A radially outer section 17, extending essentially in the axial direction, of a housing part 16, is connected to the disk-like part 14 by a plurality of threaded bolts 18. The radially inward-extending, ring-shaped section 20 of the housing part 16 forms an opposing support area for the two clutch areas 22, 24 of the dual clutch 10, which will be described in greater detail below. Another housing part 26 is rigidly connected by its radially outer section 28, which also extends essentially in the axial direction, to the housing part 16 by a plurality of threaded bolts 30. A radially inward-projecting, ring-shaped section 32 of the housing part 26 serves to support the housing, i.e., to support it with freedom of rotation, on an actuating mechanism 34 by way of a bearing 36.

The first clutch area 22 of the dual clutch 10 comprises a pressure plate 38, which is installed on one axial side of the opposing support area 20, which is attached to the housing arrangement 12 or is formed by it. The friction surface arrangement 44, comprising friction linings 40, 42 of a clutch disk 46 of the first clutch area 22, is situated between this pressure plate 38 and the opposing support area 20. In the exemplary embodiment shown, the clutch disk 46 is designed with a torsional vibration damper 47. In its radially inner area, the clutch disk 46 is designed to be connected by its hub 48 nonrotatably to a first power takeoff shaft or transmission input shaft 51.

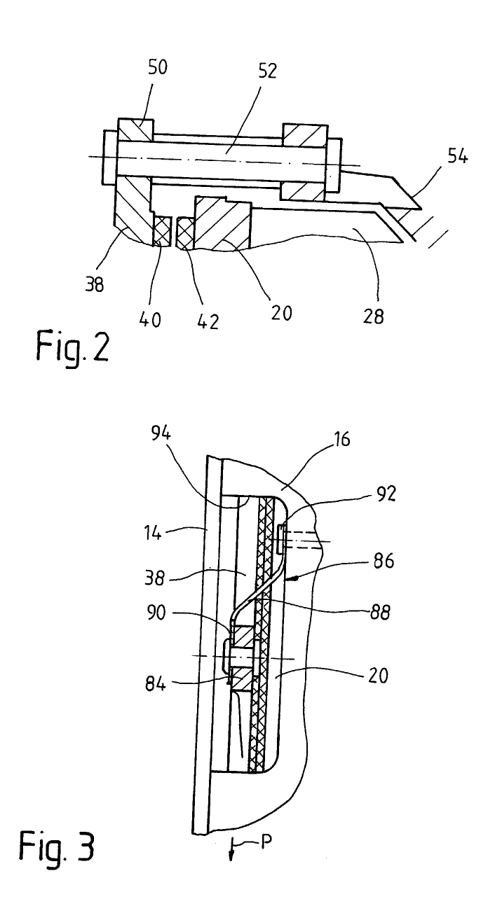

As can be seen in FIG. 2, the pressure plate 38 has radial projections 50 in its radially outer area at several points around the circumference; these projections pass radially through corresponding openings in the housing part 16 with circumferential play. These projections 50 are rigidly connected by tension rods 52 to an actuating element 54 with, for example, a ring-shaped design. The actuating element 54 is acted upon by a radially outer area 56 of an actuating force-transmitting element 58. This element is supported in its radially middle area on the outside of the section 32 of the housing part 26, and in its radially inner area 60 is acted upon by an actuating area 62 of the actuating mechanism 34. The actuating force-transmitting element 58 can be designed as a diaphragm spring, for example, but it can also comprise a force-transmitting lever arrangement with several lever elements distributed around the circumference.

The second clutch area 24 has a pressure plate 64 on the other axial side of the opposing support area 20. The friction surface arrangement 66, with its friction linings 70, 72, of a clutch disk 68 of the second clutch area 24 is situated between the pressure plate 64 and the opposing support area 20. In the exemplary embodiment shown here, the clutch disk 68 also has a torsional vibration damper 74. In its radially inner area, the clutch disk 68 is designed to be connected nonrotatably via its hub 76 to a second transmission input shaft 78, which is essentially concentric to the first transmission input shaft 51.

The radially outer part of an actuating force-transmitting element 80 of the second clutch area 24 is supported on the housing part 26, whereas its radially middle area acts on the pressure plate 64. Radially on the inside, the actuating force-transmitting element 80 is designed to be acted upon by an actuating area 82 of the actuating mechanism 34. The actuating force-transmitting element 80 can also be designed as a diaphragm spring or as a lever arrangement.

The dual clutch arrangement 10 shown in FIGS. 1-3 is of the normally-open type. When, therefore, the two actuating areas 62, 82 of the actuating mechanism 34 act on the various actuating force-transmitting elements 58, 80, a clutch-engaging force is produced, which moves the pressure plates 38, 64 toward the opposing support area 20.

The connection of the pressure plates 38, 64 to the housing arrangement 12 for rotation in common will now be described with reference to FIG. 3 and on the basis of the pressure plate 38 of the first clutch area 22. It is obvious that a similar arrangement of this type can also be provided in the area of the second clutch area 24, and it would be advantageous to do so.

The pressure plate 38 has radial projections 84 at several points around the circumference; these projections can be identical to the radial projections 50, for example, illustrated in FIG. 2. A connecting element arrangement 86 of the first clutch area 22 comprises a plurality of leaf spring elements 88 distributed around the circumference. A first circumferential end area 90 of each of these elements is riveted, for example, to a radial projection 84 of the pressure plate 38, whereas each of the associated second circumferential end areas 92 is attached to the housing part 16 in the area of, for example, the openings 94, through which the radial projections 50 or 84 pass. It can be seen in FIG. 3 that the attachment to the housing part 16 is offset in the direction of the axis of rotation A with respect to the attachment to the pressure plate 38 in the direction toward the opposing support area 20. This results in an arrangement in which the leaf spring elements 88 are curved or cranked in the area between their two end areas 90, 92. By appropriate deformation of the leaf spring elements 88, furthermore, it can also be ensured that they produce the required releasing force for the pressure plate 38, which force acts against the engaging force produced by the actuating area 62.

If the clutch area 22 is in the torque-transmitting state, that is, if the clutch is in the state in which the friction linings 40, 42 are in frictional interaction with the pressure plate 38 and the opposing support area 20, then, as a result of the transmitted torque, the clutch disk 46 exerts a force on the pressure plate 38 acting in the direction of arrow P in FIG. 3 with respect to the housing arrangement 12 or housing part 16. After the pressure plate 38 has turned a short distance relative to the housing part 16, the leaf spring elements 88 prevent it from turning any farther. Because of the slanted position of the leaf spring elements 88 in the area between the two end areas 90, 92, however, some of the force acting in the circumferential direction is deflected, and a force acting on the pressure plate 38 in the direction toward the opposing support area 20 is generated. This force increases the pressure with which the pressure plate 38 is pressed against the friction linings 40, 42, so that the transmitted torque, working in cooperation with appropriately designed leaf spring elements 88, produces a self-reinforcing effect. When a dual clutch 10, i.e., the associated clutch areas 22, 24 of the clutch, is being designed for a specific maximum clutch torque, it can therefore be taken into account that this maximum clutch torque does not have to be generated exclusively by the force exerted by the actuating mechanism 34 and that an auxiliary force component can be contributed by the associated leaf spring elements 88. This means that the dimensions of the actuating mechanism 34 can be reduced.

It should be pointed out here that, to achieve the self-reinforcing effect, the connecting element arrangement can be implemented in a wide variety of different ways. Instead of connecting elements in the form of leaf springs subjected to tension, for example, or some other type of elastic elements, it would be possible to provide thrust-actuated lever elements, one end of each lever being supported on the housing arrangement 12, the other end on the associated pressure plate 38, 64, i.e., on a section located axially closer to the opposing support area 20. Associated ramp-like sections of the pressure plate and the housing arrangement which cooperate with each other in the area of, for example, the radial projections 84 could also be used to produce the self-reinforcing effect.

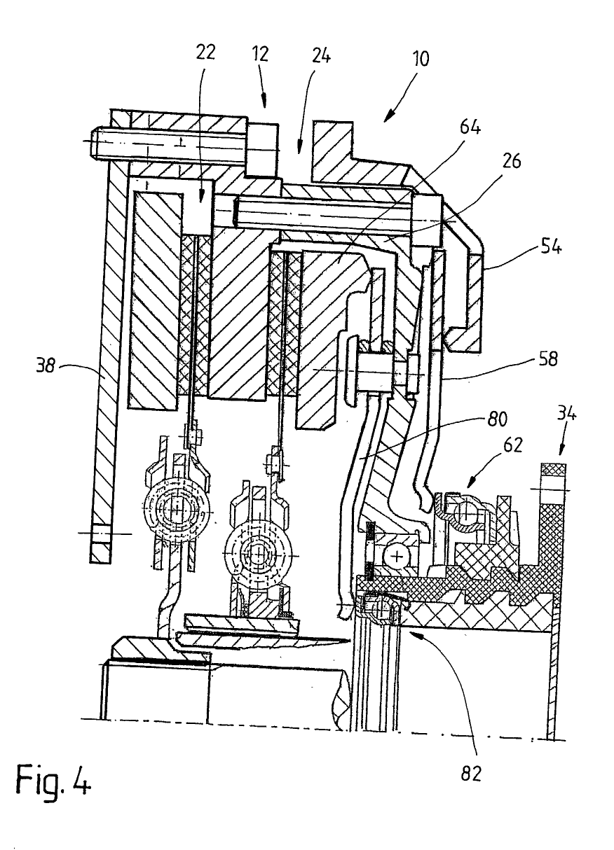

FIG. 4 shows a modified version of the dual clutch 10 according to FIG. 1. Components which have already been described with respect to their design or function are designated by the same reference numbers. Only the differences with respect to the design will be explained below.

Whereas the clutch areas 22, 24 of the dual clutch 10 shown in FIGS. 1-3 are designed as normally open clutch areas, as previously explained, the two clutch areas 22, 24 of the dual clutch 10 shown in FIG. 4 are of the normally closed type. The actuating force-transmitting elements 58, 80 are preferably designed as diaphragm springs, the radially inner areas of which are acted upon by the actuating areas 62, 82 with a pushing type of action to execute the clutch-release operation. The radially outer part of the diaphragm spring 58 of the first clutch areas 22 is supported on the housing part 26, while its radially middle part acts on the ring-shaped actuating element 54. The radially outer area of the diaphragm spring 80 of the second clutch area 24 acts on the pressure plate 64, whereas its radially middle area is supported with respect to the housing arrangement 12.

Although obvious, it should nevertheless be pointed out that a combination of clutch areas of the normally open type and of the normally closed type can also be used. Regardless of the selected combination, the previously described design of the clutch arrangements in question lead to the self-reinforcing effect, which is advantageous in the form of reducing the actuating force, i.e., the clutch-release force or the clutch-engaging force.

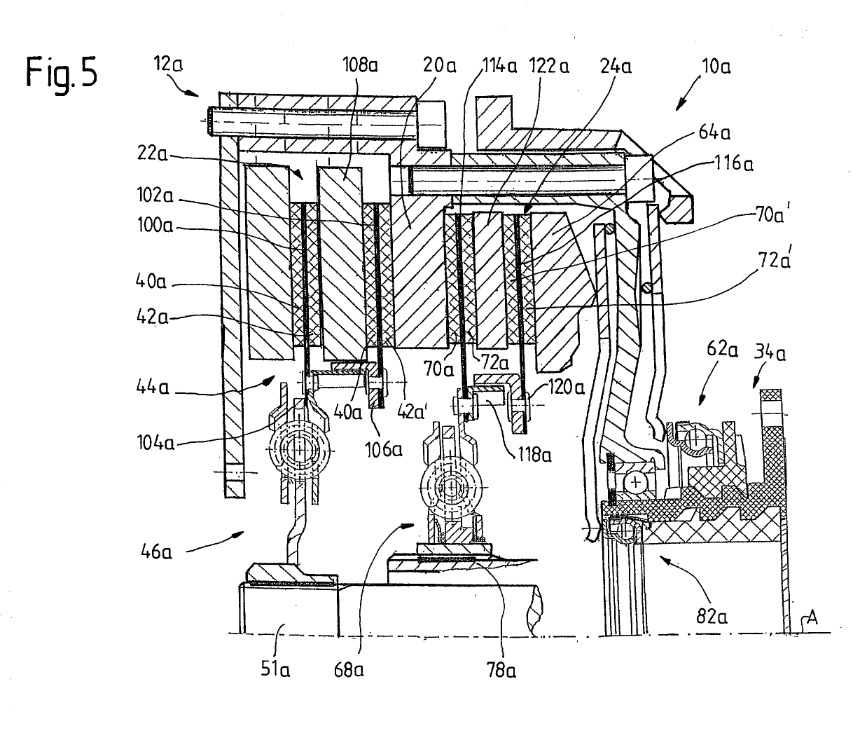

FIG. 5 shows yet another embodiment of a dual clutch according to the invention. Components which have already been described above with respect to their design and function are designated by the same reference numbers with the addition of an “a”.

First it should be explained that, with respect to its basic design and function, the dual clutch 10a shown in FIG. 5 is essentially the same as the dual clutch 10 according to FIG. 1. This means that, here, too, a dual clutch of the normally-open type is provided, in which the clutch-engaging force for the two clutch areas 22a, 24a is produced via the actuating areas 62a, 82a. It can be seen, however, that the two clutch areas 22a, 24a are designed as so-called multi-disk clutches. Thus the clutch disk 46a of the first clutch area 22a has two pairs of friction linings 40a, 42a, 40a′, 42a′. Each of these pairs of friction linings 40a, 42a; 40a′, 42a′ of the friction surface arrangement 44a is carried by a carrier element, such as an elastic lining support element 100a, 102a. Each of these carrier elements 100a, 102a is in turn attached to a preferably ring-shaped toothed element 104a, 106a. The toothed elements 104a, 106a have spur gear teeth, which are in circumferential engagement with each other but which allow the two carrier elements 100a, 102a to shift axially with respect to each other.

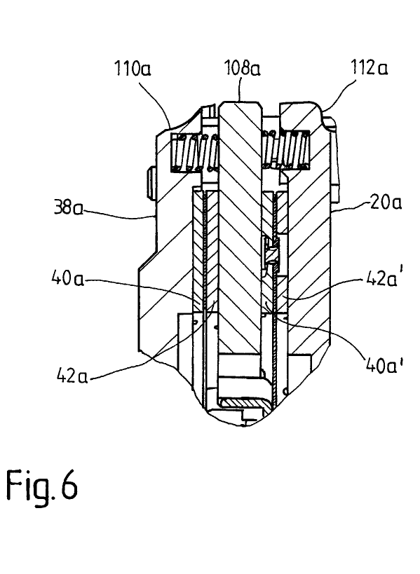

An intermediate plate 108a is installed between the two pairs of friction linings 40a, 42a and 40a′, 42a′. This plate is connected by, for example, radial projections or the like to the housing arrangement 12a so that it cannot rotate relative to the housing but can shift in the axial direction. It can be seen in FIG. 6, for example, that pretensioning elements, designed as, for example, helical compression springs 110a, 112a, act on both sides of this intermediate plate 108a; these pretensioning elements are supported against the pressure plate 38a on one side and against the opposing support area 20a on the other. In this way, it is ensured that the intermediate plate 108a is held in an approximately central position between the pressure plate 38a and the opposing support area 20a even when the clutch is released.

In a corresponding manner, the clutch disk 68a of the second clutch area 24a is also equipped with two pairs of friction linings 70a, 72a; 70a′, 72a′ and the carriers 114a, 116a assigned to them. These carriers 114a, 116a are also connected to preferably ring-shaped toothed elements 118a, 120a, which connect the two pairs of friction linings again in such a way that they cannot rotate with respect to each other but can shift relative to each other in the axial direction. An intermediate plate 122a, which can again be supported axially by springs with respect to the opposing support area 20a on the one side and against the pressure plate 64a on the other, as illustrated in FIG. 6, is connected to the housing arrangement 12a so that it cannot rotate relative to the housing but can shift in the axial direction.

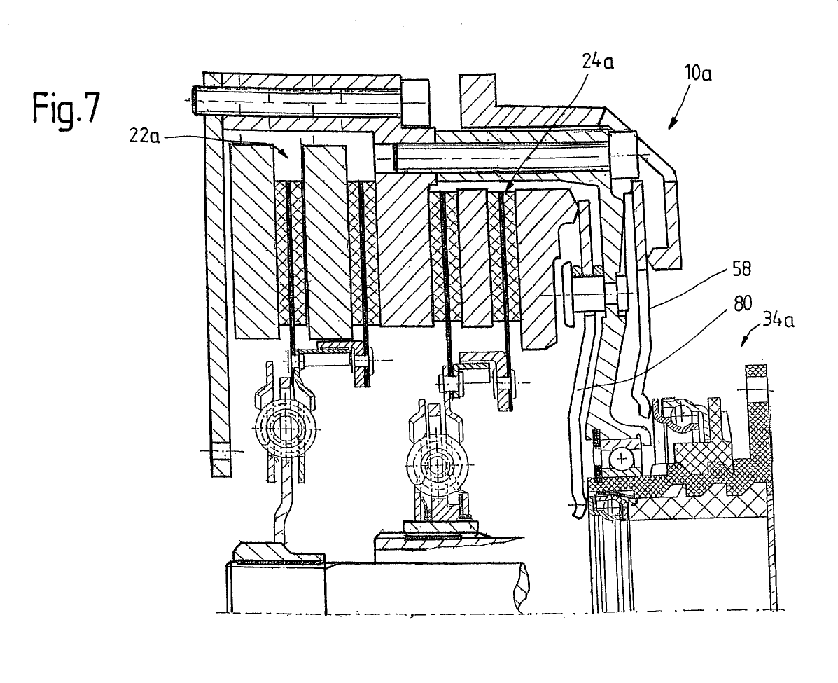

Through the use of these types of multi-disk clutch areas, the total available frictional surface area is nearly doubled in each of the clutch areas. This means that, to obtain a specified maximum clutch torque, the clutch-engaging force to be provided for the clutch areas in question can be cut in half in comparison to that required for a single-disk clutch. The 50% reduction in the clutch-engaging force also means, however, that the associated actuating areas 62a, 82a and/or the actuating mechanism 34a can be made smaller and thus can react more quickly to actuation measures. This is true both for the dual clutch 10a of the normally open type shown in FIG. 5, in which the actuating mechanism 34a produces the forces required to engage the two clutch areas 22a, 24a, and for the dual clutch 10a shown in FIG. 7, the basic design of which is the same as that of the embodiment shown in FIG. 5, but which, in a manner similar to that previously described in conjunction with FIG. 4, is of the normally closed type. Here, therefore, the actuating mechanism 34a for the two clutch area 22a, 24a produces the force required to release the clutch, which force therefore acts in the direction opposite that being exerted by the actuating force-transmitting elements 58a, 80a, which are designed as diaphragm springs.

The various measures proposed by the present invention have the result that the forces required to actuate a dual clutch can be significantly reduced without impairment to the torque-transmitting capacity. This means, first, that the various actuating mechanisms can be made lighter in weight and simpler in design and, second, that the clutch can be operated more quickly, because the forces to be applied are smaller.

It should be pointed out that the dual clutch arrangements of the present invention can obviously also be designed in different ways in various areas without deviating from the principles of the present invention. Thus, for example, the clutch disks can be designed with or without torsional vibration dampers. The various friction linings or friction surface arrangements of the clutch disks can also be designed in any way desired. It is also possible for the various components subjected to frictional forces such as the pressure plates and the opposing support area to be made up of several layers, with a material with a lower coefficient of thermal expansion in the area closer to the friction lining and with a material with a higher coefficient of thermal expansion in the area farther away from the friction lining. Because high temperatures will prevail in the area closer to the friction lining, it is possible in this way to ensure that the thermal expansion which occurs will be approximately uniform over the entire thickness of these components. The means in turn that shielding effects, which lead to excessive wear, can be avoided. It should also be pointed out that the actuating mechanism can be designed in any suitable way. Thus, instead of the actuating areas which are operated by rotational actuation as shown here, master/slave cylinder arrangements could also obviously be used, as well as conventional known release forks.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A multi-clutch arrangement comprising
a housing,
a pair of pressure plates, each pressure plate being connected to said housing for rotation in common about an axis of rotation and being shiftable in the axial direction relative to said housing;
an opposing support arranged between said pressure plates;
at least one clutch disk arranged between each of said pressure plates and said opposing support, each said clutch disk having a friction surface arrangement which can be clamped between a respective said pressure plate and the opposing support, each said clutch disk being connectable nonrotatably to a different power take-off element; and
a connecting element arrangement connecting said at least one of said pressure plates to said housing for rotation in common, said connecting element arrangement urging said at least one of said pressure plates toward said opposing support when the respective at least one friction surface arrangement is clamped between said pressure plate and said opposing support.

2. A multi-clutch arrangement as in claim 1 wherein said connecting element arrangement comprises at least one leaf spring element having a first circumferential end connected to the pressure plate and a second circumferential end connected to the housing, said second circumferential end being offset with respect to said first circumferential end toward said opposing support.

3. A multi-clutch arrangement as in claim 2 wherein said connecting element arrangement comprises a plurality of said left spring elements distributed circumferentially.

4. A multi-clutch arrangement as in claim 2 wherein each said leaf spring element comprises at least one leaf spring.

5. A multi-clutch arrangement comprising
a housing,
a pair of pressure plates, each pressure plate being connected to said housing for rotation in common about an axis of rotation and being shiftable in the axial direction relative to said housing;
an opposing support arranged between said pressure plates;
at least one clutch disk arranged between each of said pressure plates and said opposing support, each said clutch disk having a friction surface arrangement which can be clamped between a respective said pressure plate and the opposing support, each said clutch disk being connectable nonrotatably to a different power take-off element, each said clutch disk comprising a plurality of friction areas connected for rotation in common, said friction areas comprising at least one pair of mutually facing friction surfaces; and
an intermediate plate arranged between each pair of mutually facing friction surfaces, each said intermediate plate being connected to said housing for rotation in common and being shiftable in the axial direction relative to said housing.

6. A multi-clutch arrangement as in claim 5 wherein said friction areas are connected for rotation in common by circumferentially engaging teeth which permit relative axial movement.

7. A multi-clutch arrangement as in claim 5 further comprising at least one connecting element arrangement connecting said at least one of said pressure plates to said housing for rotation in common, said connecting element arrangement urging said at least one of said pressure plates toward said opposing support when the respective at least one friction surface arrangement is clamped between said pressure plate and said opposing support.

8. A multi-clutch arrangement as in claim 5 wherein at least one of said pressure plates is pretensioned to clamp a respective said at least one clutch disk between said at least one of said pressure plates and said opposing support, said multi-clutch arrangement further comprising an actuating mechanism for moving said pressure plate to a released position.

9. A multi-clutch arrangement as in claim 5 further comprising an actuating mechanism for moving at least one of said pressure plates to an engaged position where a respective said at least one clutch disk is clamped between said pressure plate and said opposing support.

10. A multi-clutch arrangement as in claim 1 wherein at least one of said pressure plates is pretensioned to clamp a respective said at least one clutch disk between said at least one of said pressure plates and said opposing support, said multi-clutch arrangement further comprising an actuating mechanism for moving said pressure plate to a released position.

11. A multi-clutch arrangement as in claim 1 further comprising an actuating mechanism for moving at least one of said pressure plates to an engaged position where a respective said at least one clutch disk is clamped between said pressure plate and said opposing support.
